(19) United States
(12) Patent Application Publication
(10) Pub. No.: US 2006/0160489 A1
(43) Pub. Date: Jul. 20, 2006

(54) Method and system for multiple 60GHz system antennae

(76) Inventor: Robert Hardacker, Escondido, CA (US)

Correspondence Address: ROGITZ & ASSOCIATES, 750 B STREET, SUITE 3120, SAN DIEGO, CA, 92101, US

(21) Appl. No.: 11/035,845

(22) Filed: Jan. 14, 2005

(51) Int. Cl. H04B 7/00

(52) U.S. Cl. 455/66.1; 455/101

(57) ABSTRACT

In a wireless 60GHz data communication system, one or both of the source and receiver can have multiple antennae, with the antenna providing the best signal strength being dynamically selected. In this way, if a person or other object momentarily crosses between the source and receiver, blocking data communication from one antenna, the other antenna can be used.

I. Field of the invention

The present invention relates generally to 60 GHz wireless transmission systems.

II. Background

The wireless spectrum between 57 Ghz and 64 Ghz (hereinafter “60 Ghz band”) is unlicensed by the U.S. Federal Communications Commission, to give organizations the opportunity, unfettered by excessive regulations, to use this spectrum for implementing wireless local area networks (LANs). The wireless LANs, in turn, can be used in a large number of applications owing to the characteristics of the 60 Ghz spectrum, which include short range, high directivity (and, hence, inherent security), and large data bandwidth.

Originally used for covert satellite-to-satellite communications (the Earth's atmosphere severely attenuates signals with frequencies around 60 Ghz), current applications for 60 Ghz wireless LANs include communications between a bank customer and an automatic teller machine, “last-mile” extension of wider area networks, and many other applications in which wireless, high bandwidth, yet localized and inherently secure data communication is desired. As an example, in Sony's co-pending U.S. patent application Ser. No. 10/666,724, incorporated herein by reference, a system is disclosed for sending high definition (HD) video in High Definition Multimedia Interface (HDMI) format from a laptop computer on a table in a room to a video projector mounted on the ceiling using a high bandwidth 60 Ghz link. At this frequency the signal has very short range and can be directional such that the video may be transmitted in an uncompressed form such that so much data is transmitted each second that bootlegging the content is essentially untenable. Additionally, the encryption methodology known as High-Bandwidth Digital Content Protection (HDCP) that is used with HDMI is untouched and left fully intact.

Regardless of the particular application, the present invention makes the following critical observation about 60 Ghz wireless links. As understood herein and touched on above, 60 Ghz wireless links are line of sight (or reflected line of sight) with relatively narrow azimuthal coverage, i.e., 60 Ghz links are highly directional. Indeed, the directionality of 60 Ghz links is such that multiple 60 Ghz transmitter-receiver pairs can exist together in the same room without interfering with each other. As recognized herein, however, this high directionality, which is advantageous from the standpoint of security and many desired operations, can result in dropped communication if the link is temporarily broken by an intervening object, such as a person walking across the line of sight between the transmitter and receiver. For HDMI applications, this results in an annoying if momentary loss of picture.

### SUMMARY OF THE INVENTION

A system includes a source of data having a source housing and a forward channel transmission path in the source housing and configured for processing data for wireless transmission in the 60 Ghz band. The system also includes a receiver of data having a receiver housing and a forward channel reception path in the receiver housing configured for processing data wirelessly received from the source of data in the 60 Ghz band. At least two 60 Ghz antennae are electrically connectable to one of: the transmission path, and the reception path.

In illustrative embodiments first and second 60 Ghz source antennae are electrically connectable to the forward channel transmission path and first and second 60 Ghz receiver antennae are electrically connectable to the forward channel reception path. The source antennae can be mounted on the source housing while the receiver antennae can be mounted on the receiver housing.

Logic advantageously may be provided for selecting one of the antennae based on signal strength. In some implementations the logic selects the antenna yielding the lowest bit error rate at the receiver, or the lowest automatic gain adjust voltage at the receiver. In addition, the logic may include sending information from the receiver to the source to cause the source to change which antenna is selected for transmission. A switch can be provided that may be configured to select which antenna to use for data communication.

In another aspect, a method for transmitting data includes providing a source of data and a receiver of data, and establishing a 60 Ghz wireless link between the source and receiver. The method also includes providing plural 60 Ghz antennae on at least one of the source and receiver, and then dynamically selecting which antenna to use for data communication in the 60 Ghz band between the source and receiver.

In still another aspect, a wireless data communication component includes at least one data conveyance path configured for processing data for transmission and/or reception over a 60 Ghz wireless link. At least two 60 Ghz antennae are electrically connectable to the data conveyance path. Means are provided for electrically connecting one or both of the antennae to the data conveyance path.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present system, showing only a forward channel for clarity of disclosure;

FIG. 2 is a flow chart of a first implementation of the present logic;

FIG. 3 is a flow chart of a second implementation of the present logic; and

FIG. 4 is a flow chart of a third implementation of the present logic.

### DETAILED DESCRIPTION OF THE PREFERRED EMBODIMENT

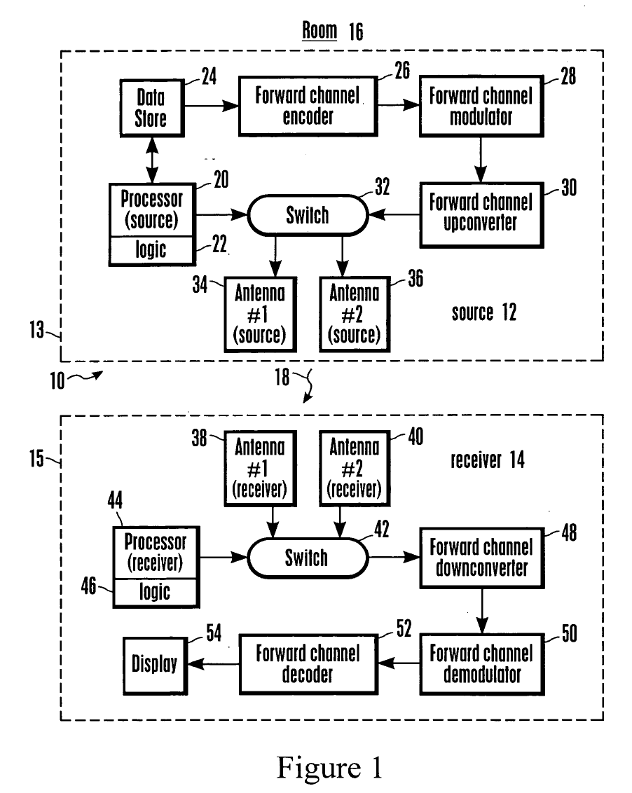

It is to be understood that FIG. 1 shows one non-limiting 60 Ghz wireless transmission system for illustration. The principles advanced herein regarding multiple antennae apply more generally to any 60 Ghz wireless transmission system.

Referring initially to FIG. 1, a system is shown, generally designated 10, which includes a source 12 of data such as HD video. The source 12 components discussed below are contained in or on a housing 13. A receiver 14 is provided for playing or otherwise using the data, and the receiver 14, which has a housing 15 holding the receiver components discussed below, is co-located with the source 12 in a room 16.

The source 12 may be a laptop computer or other multimedia computer or server. While only a single source 12 is shown, it is to be understood that more than one source 12 may be provided. For example, in addition to a laptop computer, a camcorder, a DVD player, and other multimedia sources may be in wireless communication with the receiver 14 in the room 16. The receiver 14, which may be a multimedia player such as a video projector or other player, may receive the data from the source 12 over a wireless link 18, for displaying the data. Alternatively, the receiver 14 may be a cathode ray tube (CRT), liquid crystal display (LCD), plasma display panel (PDP), or TFT for displaying multimedia data. The source 12 may be a set-top box like device capable of decoding compressed multimedia content as received from a satellite, cable, terrestrial broadcast, internet streaming, or other source. The data communication described herein may use digital visual interface (DVI) protocols. As set forth above, however, specific details in the illustrative 60 Ghz application shown are not limiting beyond the provision of multiple antennae.

The link 18 may operate at a fixed (unvarying, single-only) frequency of approximately sixty GigaHertz (60 Ghz), and more preferably in the range of 57 Ghz-64 Ghz, and the link 18 can have a data rate, preferably fixed, of up to two Giga bits per second (2.0 Gbps). Various modulation schemes may increase the data rate, e.g., when DQPSK is used the data rate may be 2.2 Gbps, and the link may have a data rate of approximately 2.5 Gbps. The link may have a fixed bandwidth of up to seven GigaHertz (7 Ghz). Error correction appropriate for wireless transmission (e.g., Reed-Solomon encoding) as well as appropriate re-multiplexing (e.g., by re-multiplexing twenty four lines of video and appropriate control signals into two in the case of QPSK modulation) may be implemented in some applications accordance with wireless transmission principles known in the art.

As shown in FIG. 1, the source 12 can include a source processor 20 that can access a logic module 22 such as RAM, ROM, or any other data storage or memory containing computer-executable software or other logic for executing the method set forth herein. The processor 20 can access a data store 24 such as a hard disk drive, CD, or DVD to send data along a forward channel as follows, for transmission of the data to the receiver 14.

A forward channel encoder 26 in the source 12 encodes data in accordance with principles known in the art. The encoded data is modulated by a forward channel modulator 28 and upconverted by a forward channel upconverter 30 for transmission over the link 18 at about 60 Ghz.

In accordance with present principles, a hardware or software source antenna select switch 32 may receive signals from the upconverter 30 and, under the control of the source processor 20, select which one of multiple source antennae to use for transmission. In the embodiment shown in FIG. 1, first and second source antennae 34, 36 are shown as being mounted one the source housing 13, it being understood that more than two source antennae can be used if desired. Each source antenna 34, 36 is configured as appropriate as a 60 Ghz antenna and the source antennae 34, 36 are physically spaced apart from each other on the source housing 13. Using the above-described wide channel and a simpler modulation scheme such as but not limited to DQPSK, QPSK, BPSK or 8-PSK, a high data rate yet simple system can be achieved. For example, when DQPSK is used, a data rate of twice the symbol rate can be achieved. For 8-PSK a data rate of 3.3 Gbps may be achieved. If desired, a copy protect system such as high definition copy protection (HDCP) can be used with the multimedia content in accordance with HD principles known in the art.

The wireless signal is received by first and second receiver antennae 38, 40 that are mounted on the receiver housing 15. The receiver antennae 38, 40 are configured for 60 Ghz operation and are physically spaced apart from each other on the receiver housing 15. In accordance with present principles, a hardware or software receiver antenna select switch 42 may receive signals from the receiver antennae 38, 40 and, under the control of a receiver processor 44 that can access a logic module 46 such as RAM, ROM, or any other data storage or memory containing computer-executable software or other logic for executing the method set forth herein, select which one of multiple receiver antennae to use. In the embodiment shown in FIG. 1, first and second receiver antennae 38, 40 are shown as being mounted on the receiver housing 15, it being understood that more than two receiver antennae can be used if desired.

In accordance with principles known in the art, the signal from the receiver antenna select switch 42 is downconverted at a forward channel downconverter 48 and demodulated from 60 Ghz at a forward channel demodulator 50, and then decoded at a forward channel decoder 52 that can undertake error correction and multiplexing functions. The decoded signal may be stored in a data storage device or displayed on an audio or video or audio/video display device 54. It is to be understood that reverse channel components (not shown) may be provided in accordance with principles known in the art for two-way communication. Specifically, a reverse channel transmission path can be provided in the receiver 14 that can be substantially identical in configuration and operation to the forward channel transmission path of the source 12 shown in FIG. 1. Likewise, a reverse channel reception path can be provided in the source 12 that can be substantially identical in configuration and operation to the forward channel reception path of the receiver 14 shown in FIG. 1.

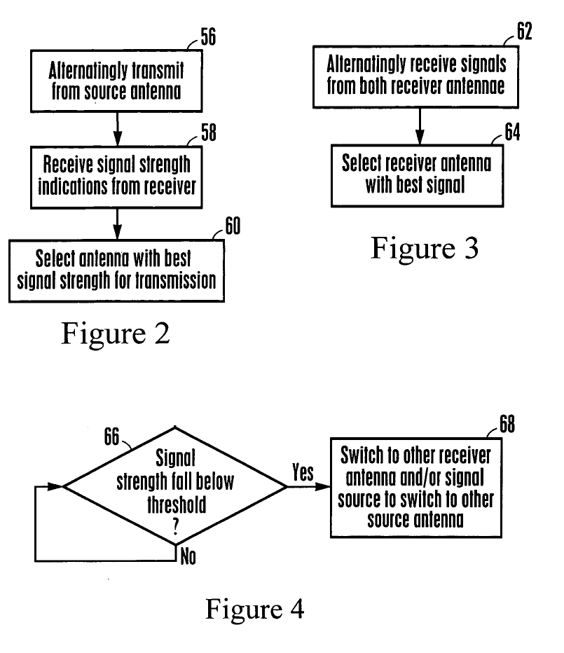

FIGS. 2-4 show non-limiting examples of the logic that can be used for dynamically selecting (selecting during operation) which source antennae 34, 36 and/or which receiver antennae 38, 40 to use. For instance, commencing at block 56 of FIG. 2, signals can be altematingly transmitted from the source antennae 34, 36 by, e.g., causing the source antenna select switch 32 to periodically and briefly switch very quickly back and forth, at least one cycle, between the source antennae 34, 36. The signal strength for the time period or periods during which the signal was transmitted over the first source antenna 34 is noted by the receiver 14 and sent back to the source 12 at block 58. Likewise, the signal strength for the time period or periods during which the signal was transmitted over the second source antenna 36 is noted by the receiver 14 and sent back to the source 12 at block 58. Then, at block 60 the source antenna 34, 36 that is associated with the best signal strength is selected and the source antenna select switch 32 configured accordingly by the source processor 20.

In determining signal strength, one or more of several parameters can be used. For instance, bit error rate can be used as an indication of which antenna is “best” for the moment, with a lower bit error rate indicating a higher or better signal strength. Or, if automatic gain adjust is implemented, the AGC setting can be used, i.e., the higher the AGC voltage the lower the signal strength, so that the antenna resulting in the lower AGC voltage would be selected.

In addition to or in lieu of the logic shown in FIG. 2, one or both of the logic flows shown in FIGS. 3 and 4 can be used. At block 62 in FIG. 3, the receiver processor 44 can configure the receiver antenna select switch 42 to alternatingly select between the receiver antennae 38, 40, with the receiver antenna yielding the best signal selected at block 64 and the receiver antenna select switch 42 configured accordingly. FIG. 4 can be used as well, in which decision diamond 66 represents the signal from the currently selected receiver antenna 38, 40 falling below a threshold. When this occurs, the receiver processor 44 reconfigures the receiver antenna select switch 42 to select the other receiver antenna at block 68. In addition to or in lieu of selecting the other receiver antenna, the receiver 14 can request the source 12 to swap its selected source antenna 34, 36 for the other source antenna 36, 34.

While the particular METHOD AND SYSTEM FOR MULTIPLE 60 Ghz SYSTEM ANTENNAE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. A system, comprising:
a source of data, the source having a source housing;
at least a forward channel transmission path in the source housing configured for processing data for wireless transmission in the 60 Ghz band;
a receiver of data, the receiver having a receiver housing;
at least a forward channel reception path in the receiver housing configured for processing data wirelessly received from the source of data in the 60 Ghz band; and
at least two 60 Ghz antennae electrically connectable to one of: the transmission path, and the reception path.

2. The system of claim 1, comprising at least first and second 60 Ghz source antennae electrically connectable to the forward channel transmission path and at least first and second 60 Ghz receiver antennae electrically connectable to the forward channel reception path.

3. The system of claim 1, wherein the at least two 60 Ghz antennae are both mounted on one of: the source housing, and the receiver housing.

4. The system of claim 3, comprising at least first and second 60 Ghz source antennae mounted on the source housing and first and second 60 Ghz receiver antennae mounted on the receiver housing.

5. The system of claim 1, comprising logic for selecting at least one of the antennae based on signal strength.

6. The system of claim 5, wherein the logic selects at least one antenna yielding the lowest bit error rate at the receiver.

7. The system of claim 5, wherein the logic selects at least one antenna yielding the lowest automatic gain adjust voltage at the receiver.

8. The system of claim 5, wherein the antennae are on the source housing, and the logic includes sending information from the receiver to the source to cause the source to change which antenna is selected for transmission.

9. The system of claim 1, comprising a switch configurable to select which antenna to use for data communication.

10. A method for transmitting data, comprising:
providing a source of data and a receiver of data;
establishing a 60 Ghz wireless link between the source and receiver;
providing plural 60 Ghz antennae on at least one of: the source and receiver; and
dynamically selecting which antenna to use for data communication in the 60 Ghz band between the source and receiver.

11. The method of claim 10, comprising providing at least first and second 60 Ghz source antennae with the source and at least first and second 60 Ghz receiver antennae with the receiver.

12. The method of claim 10, comprising selecting at least one of the antennae based on signal strength.

13. The method of claim 10, comprising selecting the antenna yielding the lowest bit error rate at the receiver.

14. The method of claim 10, comprising selecting the antenna yielding the lowest automatic gain adjust voltage at the receiver.

15. The method of claim 10, wherein the antennae are on the source, and the method includes:
sending information from the receiver to the source to cause the source to change which antenna is selected for transmission.

16. A wireless data communication component, comprising:
at least one data conveyance path configured for processing data for at least one of: transmission, and reception, over a 60 Ghz wireless link;
at least two 60 Ghz antennae electrically connectable to the data conveyance path; and
means for electrically connecting one of the antennae to the data conveyance path.

17. The component of claim 16, wherein the means for electrically connecting includes a processor-controlled switch.

18. The component of claim 16, wherein the means for electrically connecting connects one and only one antenna at a time to the data conveyance path.

19. The component of claim 16, wherein the means for electrically connecting connects an antenna to the data conveyance path based at least in part on a bit error rate.

20. The component of claim 16, wherein the means for electrically connecting connects an antenna to the data conveyance path based at least in part on an AGC voltage.
